(19) United States
(12) Patent Application Publication
(10) Pub. No.: US 2011/0099828 A1
(43) Pub. Date: May 5, 2011

(54) COMPACT TAPE MEASURE

(75) Inventor: Hector R. Hernandez, Fullerton, CA (US)

(73) Assignee: ALLTRADE TOOLS LLC, Long Beach, CA (US)

(21) Appl. No.: 12/610,017

(22) Filed: Oct. 30, 2009

(51) Int. Cl. G01B 3/10

(52) U.S. Cl. 33/757; 33/761; 33/769

(57) ABSTRACT

A compact tape measure is described that includes novel and useful features that allow a spring retractable tape measure to occupy a compact space. Specifically, the tape measure of the invention configures at least one flat coil return spring to be located alongside, and not in the same plane as, a flat coiled tape measure blade, thereby permitting a reduction in the dimension of the tape measure taken along a diameter of the coiled tape blade, and at the same time expanding the width of the tape measure to provide a tape measure with more compact characteristics than tape measures that are elongate and narrow.

### FIELD OF THE INVENTION

The present invention relates to spring retraction tape measures. Specifically, the invention relates to a novel compact tape measure in which the novel spring retraction mechanism is configured to permit the tape measure to assume a highly compact shape such as a ball or sphere. The invention further relates to novel features of the blade of the tape measure, specifically, to a blade with a large height and curvature for producing a long standout.

### BACKGROUND

Hand held spring return tape measures are known in the art. A typical hand held spring return tape measure is exemplified in FIG. 6, which shows a tape measure 100 contained in a housing 102 and that includes an extendable elongate tape blade 104 rolled into a flat spiral coil. (Being flat, the spiral coil lies in a plane). A return spring 109, also in the form of a flat spiral coil, is positioned in the same plane as the tape blade and occupies a space inside an internal diameter of the spiral tape blade. A cylindrical drum 108 separates the blade and the return spring, and the blade is mounted on the drum. The drum rotates about a fixed axle 112 attached to the housing 102. An internal terminal end 120 of the tape blade is connected to the drum 108, and an external terminal tip 106 of the tape blade extends from a slot opening in the housing. An external terminal end 118 of the return spring is connected to the drum 108, and an internal terminal end 116 of the return spring is attached to the fixed axle 112. The return spring is wound in the opposite direction to the tape blade so that, when the tape blade 104 (mounted on the drum) rotates about the common axis it causes the drum to rotate, and this in turn winds the return spring into a compressed state. Thus, the user may pull the leading tip 106 of the blade from the housing 102, causing the blade to uncoil and to extend a desired length outside the housing. As the tape is pulled from the housing it causes the drum 108 to rotate, and hence to wind the return spring 109 into a compressed coiled state. Conversely, when the user releases the blade outside the housing, the return spring 109 unwinds from its compressed state and urges the blade to rewind on the drum 108 and return into the housing 102. A brake button 114 may be depressed by the user to provide a friction brake for halting rotation of the blade.

A problem that arises in manufacturing tape measures of the kind described above is that they are difficult to make in compact form. Under the configuration described above, a tape measure having a blade length of about 25 feet, effectively has a dimension, taken along the diameter of the coiled tape blade (the largest dimension of the tape measure), that is typically about 3.5 inches. Attempts to reduce this diameter in a manufactured product usually require the length of the blade to be reduced, which may defeat the purpose of the tape measure. Achieving compactness is desirable because the more compact a tape measure can be made, the more robust it is to external forces such as being dropped on a hard surface.

Therefore, there is a need in the art for a tape measure configuration that can overcome the problems in the prior art. The present invention addresses these and other needs.

Another problem that is found in the art is the following. Some tape measures are manufactured to provide a large tape blade “standout” length. In other words, the tape blade will extend from the housing of the tape measure for a “standout” length up to about 10 feet without buckling under its own weight. A large standout length is useful in that it allows a user to take measurements over a large length without the assistance of a helper to hold the remote tip of the tape blade. A helper is sometimes required where there is no edge available on the object at the remote end, to snag a hook connected to the tip of the blade. A commonly used technique to achieve a large standout is to provide the transverse cross section of the blade with a concave shape, such as seen in FIG. 8. The concave section may be given two dimensional attributes: First, it may be given a large height (shown as “H” in FIG. 8), which is the vertical distance between the lowest point on the cross section and the highest point. Second, it may be given a large width (shown as “W” in FIG. 8), which is the horizontal distance between the outermost points on the cross section. The resulting blade may have a single cross sectional radius (shown as “R” in FIG. 8) with a single center, or it may be given a more complex sectional shape, with more than one radius, each having its own center. For a tape blade to have a standout length in the region of 10 feet, it may be necessary for the tape to have a width that is in the range of 1.0 to 1.5 inches and a height in the range of 0.5 to 0.8 inches.

But a problem that emerges in a blade with a large standout of the kind described is that it may be difficult for the user to mark with a pencil the correct length on the object being measured. This arises because the tape blade typically rests on the object at its lowest point on the cross section, while the measuring index is located at an edge of the blade, which will be elevated from the object by the amount “H” as seen in FIG. 8. Thus, an error due to parallax may arise in which the user's eye may be positioned out of alignment with the measuring index and the pencil tip. This is a disadvantageous result.

Thus, there is a need in the art for a curved tape blade that addresses the problem described above. The present invention addresses these and other needs.

### SUMMARY OF THE INVENTION

In a preferred embodiment of the invention, a compact tape measure having features of the present invention is described, comprising a housing and an axle extending through the housing, the axle being rotationally fixed to the housing. A spool is provided, the spool having a tubular portion defining a bore shaped to receive the axle. Thus, the spool is configured to rotate about the axle, and the spool further includes at least one skirt rotationally fixed to the tubular portion. The purpose of the skirt is to provide a point on the spool that has a radius larger than the radius of the tubular portion, in which the point rotates in unison with the tubular portion of the spool, and that is capable of being attached to, and rotating, an external end of a flat coiled spring, as described in more detail below, in order to compress and decompress the flat coiled spring.

A flat coiled tape is provided. The flat coiled tape lies in a first plane and has an inner terminal end and an outer terminal end. The inner terminal end of the tape is attached to the tubular portion so that the flat coiled tape rotates in unison with the spool. The outer terminal end extends from an opening in the housing and is configured to be withdrawn away from the housing to progressively unwind the coiled tape which results in rotating the coiled tape and the spool in a first direction.

At least one flat coiled spring is provided. The flat coiled spring lies in a second plane adjacent to the first plane and has an inner terminal end and an outer terminal end, the inner terminal end being attached to the axle, the outer terminal end being attached to the skirt, so that, when the spool (with skirt) rotates in the first direction the flat coiled spring is moved to a compressed condition, and when the spool rotates in a second direction opposite the first direction, the flat coiled spring moves to a decompressed condition. Thus, when the external terminal end of the coiled tape is drawn away from the housing, the coiled tape and the spool are caused to rotate about the axle in the first direction, and the coiled spring is moved to a compressed condition. Furthermore, when the external terminal end of the coiled tape is released, the coiled spring moves to the decompressed condition, thereby rotating the spool and the coiled tape in the second direction and withdrawing the tape into the housing.

In another aspect of the invention, the tubular portion defines a slot, and the inner terminal end of the flat coiled tape is attached to the tubular portion by being inserted in the slot in the tubular portion.

In yet another aspect of the invention, the at least one skirt is formed in the shape of a short hollow cylinder that is open at a first end and closed at a second end opposite the first end, a slot is defined in an outer circumference of the hollow cylinder, and the external end of the at least one flat coiled spring is attached to the skirt by being inserted into the slot in the outer circumference of the hollow cylinder. As noted above, this configuration causes the external end of the flat coiled spring to rotate when the spool rotates, but the internal end of the flat coiled spring is held stationary on the axle. By this means, rotation of the spool causes the spring to compress or decompress, depending on the direction of rotation.

In yet another aspect, the axle defines a slot, and the internal terminal end of the at least one flat coiled spring is attached to the axle by being inserted into the slot in the axle. Preferably, the at least one flat coiled spring is configured to fit within the circumference of the hollow cylinder. To add balance to the tape measure, the at least one skirt are two in number, and the at least one flat coiled spring are two in number, the two flat coiled springs being positioned about the axle to flank the flat coiled tape. With these features present in the invention, a preferred shape of the housing is a spherical profile.

Another aspect of the invention relates to the form of the blade. In this aspect, a preferred embodiment of the tape measure of the invention comprises a housing, a flat coiled tape blade positioned within the housing and configured to be withdrawn linearly from the housing, the tape blade having a curved cross sectional shape for maintaining a standout length under which the blade does not buckle under its own weight. A flat coiled spring is provided, and configured to retract the linearly withdrawn tape blade back into the housing. In one aspect of the invention, the tape blade is configured to include a series of slots extending down a center line of the tape blade and is further configured to include a measuring scale extending along an edge of the tape blade, and also to include a measuring scale extending along the center line of the tape blade adjacent the slots.

Preferably, the slots have a length between 8 mm and 15 mm, and the slots have a width of between 1.5 mm and 2 mm. Further preferably, the slots are evenly spaced. The slots may be separated from each other by a length of between 3 mm and 5 mm, and the slots may be interrupted over a length of at least one foot at a location on the blade where the maximum blade standout occurs.

These and other advantages of the invention are described below in the detailed description of the preferred embodiments, with reference to the drawings.

### BRIEF DESCRIPTION OF THE DRAWINGS

FIG. 1 shows a perspective view of a tape measure having features of the present invention.

FIG. 2 is an exploded perspective view of the tape measure of FIG. 1.

FIG. 3 is a perspective view of some assembled components of the tape measure of FIGS. 1 and 2.

FIG. 4 is an exploded perspective view of the components shown in FIG. 3.

FIG. 5 is a schematic fragmented and sectional view of components shown in FIG. 2.

FIG. 6 is a sectional side view of a tape measure known in the art.

FIG. 7 is a perspective view of the external terminal end of a tape blade, showing features of the present invention.

FIG. 8 is a cross sectional view of the tape blade of FIG. 6.

### DETAILED DESCRIPTION OF THE PREFERRED EMBODIMENTS

With reference to the figures, a tape measure having features of the present invention is described.

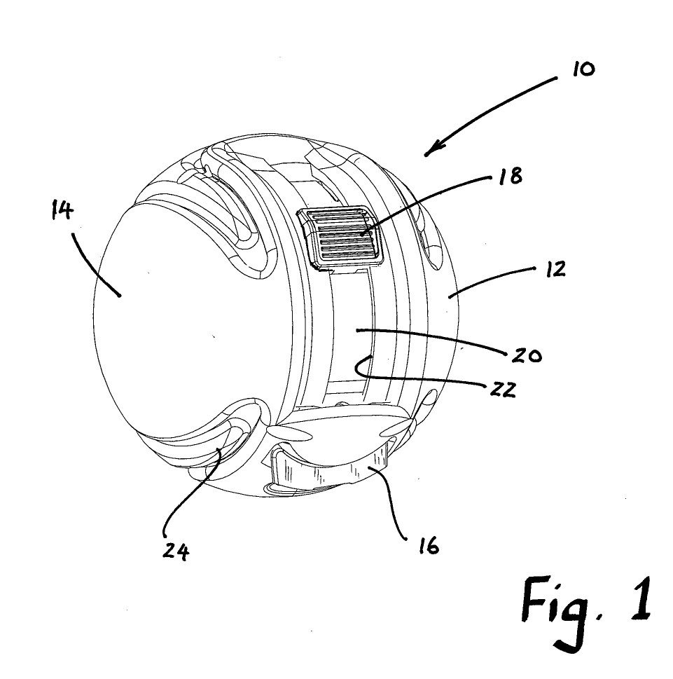

In a first aspect of the invention, and with reference to FIGS. 1-5, a novel highly compact tape measure is described. Specifically, the tape measure is compact to the extent that its height has been reduced in comparison with commonly used tape measures, and its width has been expanded, to the point that it may have a spherical shape. The tape measure 10 shown in FIGS. 1-5 has external features that include a housing made up of a first half housing 12 and a second half housing 14, configured to mate with and connect with each other. A tape blade tip 16 (seen in FIG. 1) is connected to a terminal end of a flat coiled tape blade that prevents the tape blade from being wound further inside the housing under the urging of a return spring, and has useful characteristics when used for measuring, as explained further below. The tape measure includes a brake button 18 that attaches to a brake pad 20. The button protrudes from a slot 22 (FIG. 1) in the housing. When the brake button 18 is moved downwardly in the slot, the brake pad 20 moves downwardly to lock the tape blade to prevent it from returning into the housing. (Ornamental shapes and features 24 that are not part of the present invention may be included on the surface of the housing.)

The compact shape of the tape measure adds advantages. A compact tape measure, that may even be spherical, has the advantage of being more robust than tape measures that are typically longer (and taller) than they are wide. A compact spherical tape measure has the advantage of either not having any corners, or having corners of large radius on the exterior of the housing. As such, when a compact or spherical tape is dropped and strikes on a hard surface, the impact on the housing is distributed more evenly than when the sharper corners of a rectangular tape strikes a hard surface. The housing of a compact shaped tape measure is therefore more durable, and tends to last longer under vigorous usage that may cause large impact loads.

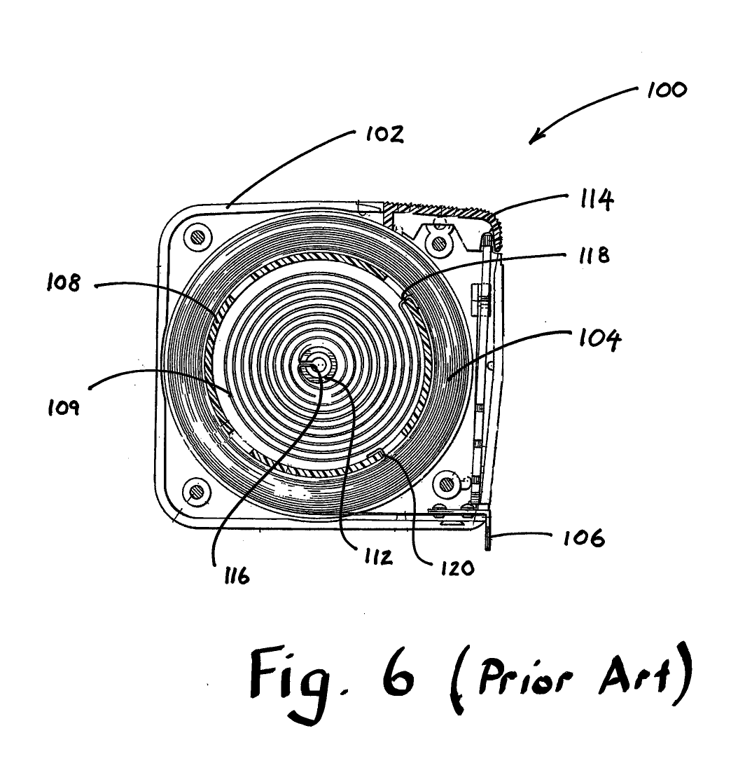

The compact or spherical shape of the tape measure of the present invention allows for a reduction in what would otherwise be the largest dimension of the tape—even while the tape measure may accommodate a tape blade of substantial length which is comparable to the length of the blade in known large tape measures. Thus, in a preferred aspect of the invention, the dimension of the tape measure taken along the diameter of the tape blade is reduced by taking the step of not locating a flat coiled return spring inside the tape blade and in the same plane as the flat coiled tape blade, as is the case in prior art tapes exemplified in FIG. 6. Rather, in a novel feature of the invention, at least one, but preferably two, flat coiled return springs are located adjacent the flat coiled tape blade to flank the coiled tape and this symmetry enhances the balance of the tape. This novel and useful configuration allows the flat coiled tape blade to be provided having a much smaller outside diameter than would be possible if the return spring were accommodated in a space inside the coiled tape blade. By using the novel structure and arrangement of placing the return spring (or, springs) adjacent the tape blade and in a different plane than the tape blade, two useful features are made possible. First, the dimension of the tape measure taken along the diameter of the tape blade may be reduced, and second, the width of the tape measure may at the same time is increased. The novel structural feature which makes these aspects of the invention possible are now described.

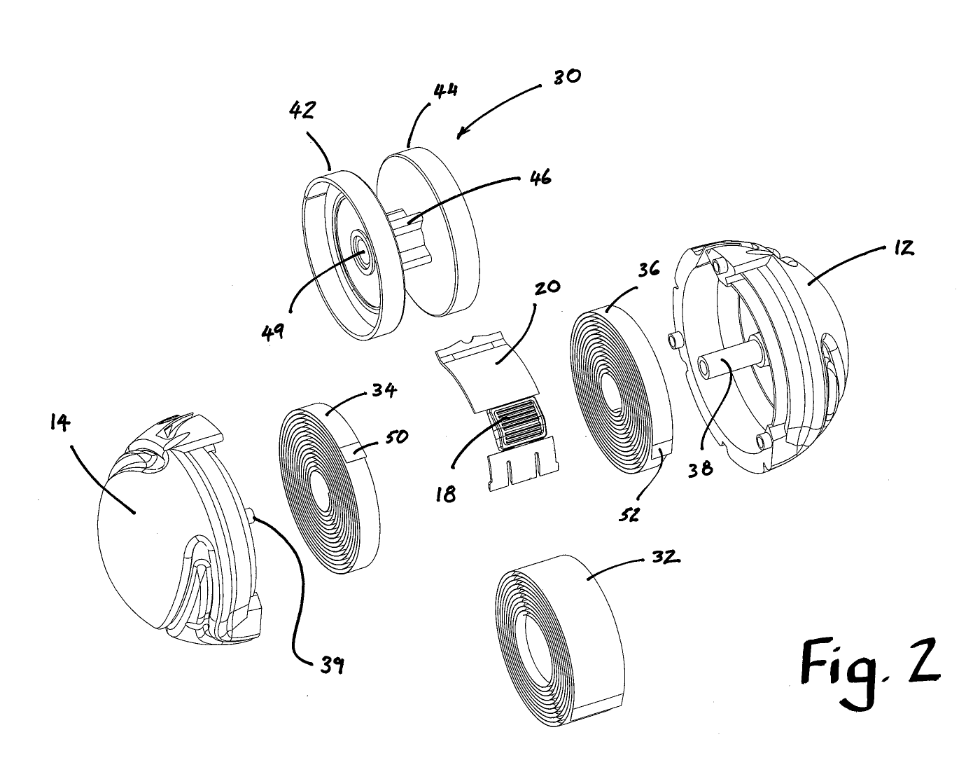

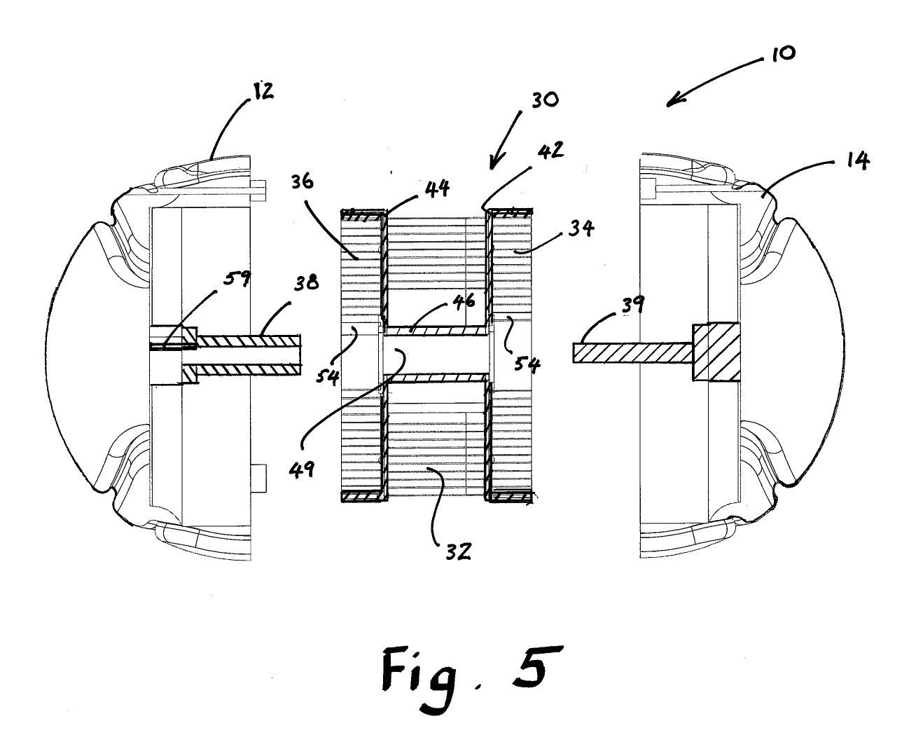

These more specific structural details of the invention are shown in FIGS. 2-5. FIG. 2 shows an exploded perspective view of some components of the tape measure having features of the invention. In particular, there is shown a first half of the housing 12 and a second half of the housing 14 that are configured to mate together and be connected by screws to form a housing. Extending from one half 12 to the other half 14 are mating male and female parts 39, 38 (best seen in FIG. 5), that provide a stationary axle, rotationally fixed to the housing, for supporting moving components of the tape measure.

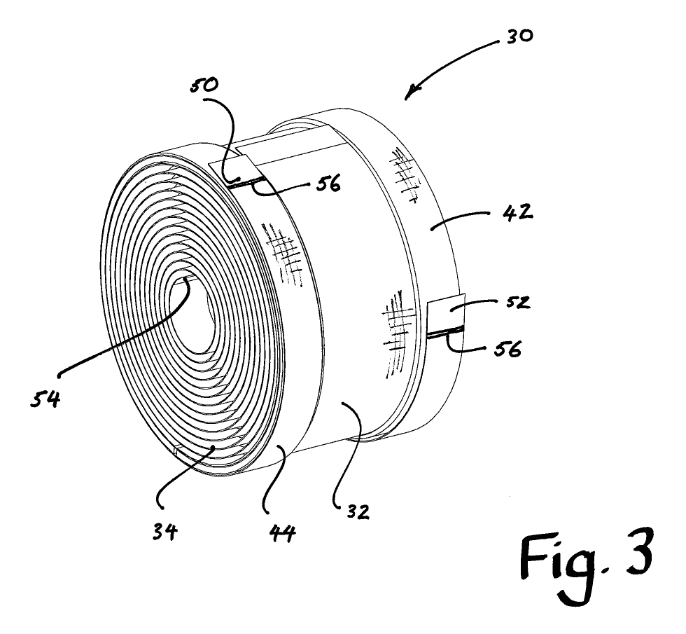

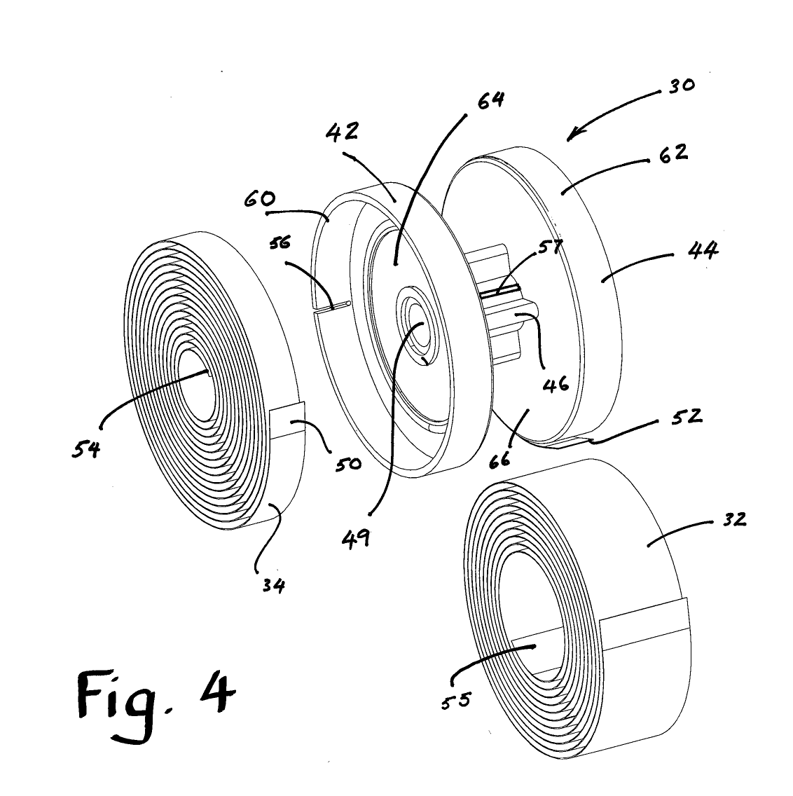

A spool 30 with a central bore 49 is provided, the bore being configured to receive the stationary axle parts 38, 39, and to permit the spool to rotate about the axle. The spool comprises a first skirt 42 and a second skirt 44 connected to each other by a tubular portion 46 that defines the bore 49. Each skirt is in the form of short a hollow cylinder, closed at one end 64, 66, and open at the opposite end. The bore 49 opens into the closed end 64, 66 of each skirt. The open ends face outwardly. The two skirts 42, 44 and axle 46 are immovably connected to each other via axle 46 so that no relative rotation takes place between them. A tape blade 32 that is wound into a flat spiral coil is installed on the axle 46 so that the blade is flanked by the two skirts 42, 44 (as seen in FIGS. 3 and 5). An interior terminal end 55 of the tape 32 is connected to the axle 46 by insertion into a slot 57 on the axle (seen in FIG. 4), thereby causing the spool 30 to rotate when the tape blade 32 rotates. Two return springs 34, 36, each in the form of a flat spiral coil, are positioned inside the hollow cylindrical portions of the skirts 44, 42 to flank the flat coiled tape 32, as seen in FIGS. 3 and 5. A internal terminal end 54 (FIG. 4), of each return spring 34, 36 is inserted into a slot 59 (seen on axle portion 38 in FIG. 5) on the stationary axle 38, 39. An external terminal end 50, 52 of each return spring is inserted into a slot, such as slot 56 (FIG. 4), on a respective skirt. Due to the configuration of each skirt, each slot 56 is positioned adjacent an outer circumference of each skirt. Importantly, the springs 44, 42 are wound in the same direction as the direction that the tape blade is wound. Thus, when the spool rotates inside the housing to release the tip 16 of the tape away from the housing, the return springs are wound into a compressed state onto the stationary axle 38, 39, thereby assuming a configuration of elevated strain energy. When the tape 32 is released, the return springs decompress to assume a configuration of reduced strain energy, and the spool 30 rotates in the other direction to retract the tape into the housing.

Thus, in operation of the tape measure, when the tip 16 of the tape blade is pulled away from the housing 30, the coiled tape blade 32 will rotate to unwind and will cause the spool 30 to rotate on the stationary axle 38, 39. As the spool rotates, the tip 16 of the blade may advance an increasing distance from the housing 12. Further, as the spool rotates, the outer circumferential portions 60, 62 of the skirts rotate, along with the slots 56 holding the outer terminal ends 50, 52 of the return springs 42, 44. Because the inner ends 54 of the return springs are held stationary on the axle 38, 39, the return springs are twisted into a compressed condition (because they are wound in the same direction as the coiled tape blade 32). When the user releases the tip 16 of the tape blade, the return springs 42, 44 are urged to decompress by releasing their stored strain energy and assume a condition with less strain energy. This action causes the return springs to uncoil, and the action rotates the spool 30, along with the tape blade 32, to rewind the entire length of tape blade back into the housing. Thus, this arrangement provides a desired result by a novel configuration that permits new and useful shape modification of the tape measure.

In the process of assembly, the following steps are taken to install the various components into the tape measure housing. First, the spool is assembled. A short connector piece having the cross sectional shape of a tape blade, and about 6 inches in length, is connected to the spool axle 46 via slot 57. To the free end of the connector piece, a dummy tape is connected, and rolled onto the spool. The dummy tape is slightly longer than the tape that will eventually be installed in the housing (the “eventual tape”). The flat coiled return springs 24, 36 are inserted into each skirt 42, 44, and their outer terminal ends 50, 52 are inserted into slots 56 on the outer portion 60, 62 of the skirts, while their inner terminal ends 54 are inserted into slots 59 on the stationary axle 38, 39. The return springs at this stage have not been wound into a compressed condition, but are in their normal uncompressed condition. The spool with mounted springs and dummy tape are then installed in the housing, mounted on the axle 38, 39, and the housing is sealed with screws. At this point, the tip of the dummy tape is pulled from the housing until the entire length of the dummy tape is exposed, and the external end of the connector piece is also exposed. It will be appreciated that, at this stage, the return springs will be wound into a compressed condition within the skirts. The dummy tape is then disconnected from the end of the connector piece, and the internal terminal end of the eventual tape is connected to the end of the connector piece instead. The eventual tape is then released, and the compressed return springs are allowed to decompress, pulling the eventual tape into the housing as the spool is urged to rewind about the stationary axle 38, 39. It will be appreciated that, because the dummy tape is slightly longer than the eventual tape, when the eventual tape is fully wound into the housing with only the tip 16 remaining outside the housing, the return springs will still be in a state of some residual compression. This condition plays an important role, because it ensures that the return springs will continue to pull the tip of the eventual tape into the housing even when the entire eventual tape is inside the housing. Without this condition, the springs might, after some usage, lose some compression strain and not have enough compression strain energy to pull the last few inches of tape into the housing.

In this way, a method is described for providing a tape measure that is retractable under spring actuation, where at least one, preferably two, flat coiled return springs are not positioned in the same plane as the flat coiled tape blade, but positioned adjacent the tape blade, flanking the blade in the case where there are two springs. This solution allows both a reduction in the manufactured longitudinal dimension of the tape housing (along the diameter of the flat coiled tape), which is simultaneously accommodated by a lateral expansion of the manufactured width of the tape housing. Both resulting conditions allow for the manufacture of a compact tape measure housing that has advantages over the prior art. The described invention may, of course, be carried out in other specific ways than those herein set forth without departing from the essential characteristics of the invention. The present embodiments are, therefore, to be considered in all respects as illustrative and not restrictive.

In a second aspect of the invention a problem in using a highly curved tape blade, identified above, is addressed. As noted, prior art tape blades that are designed to achieve a large “standout” are typically wide (in the range of 1 inches to 2 inches wide) and have a large height (shown as “H” in FIG. 8). This configuration introduces a problem of parallax, in which a user who attempts to inscribe a pencil mark at a certain distance on a work piece (such as a piece of lumber), may have difficulty in lining up the measuring index on the edge of the tape blade with the end of his pencil on the surface of the object being measured. This can be frustrating, and may lead to incorrect inscribed measurements being made due to parallax.

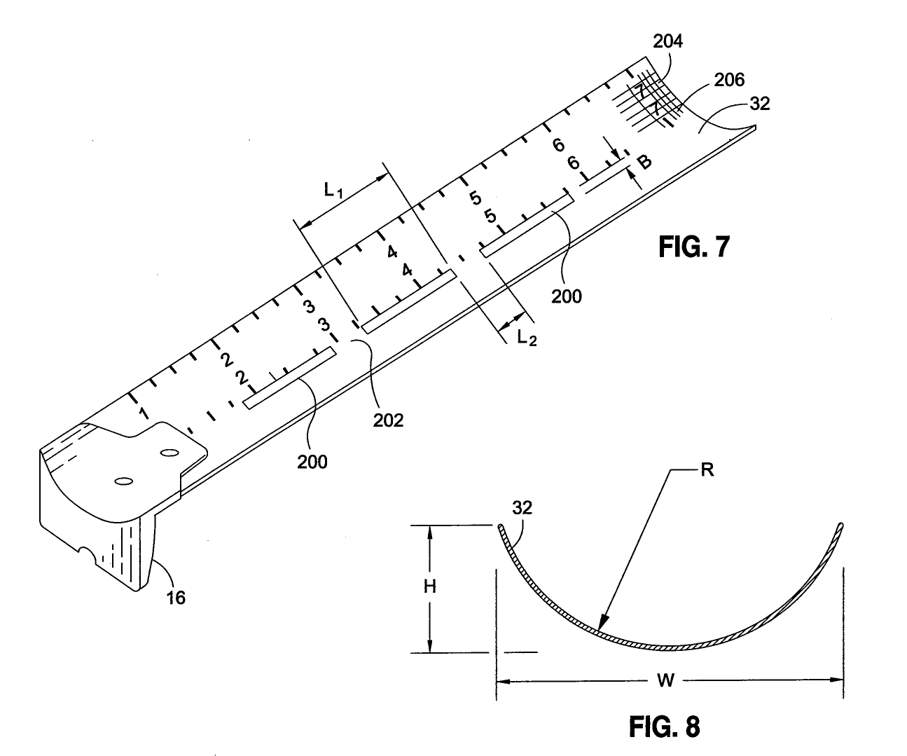

With reference to FIG. 7, a solution that the present invention introduces in a preferred embodiment is to create a sequence of slots 200 into the lowest point on the cross section of the blade (lowest being taken, with reference to FIG. 7, as the midpoint of the cross section of the blade). The slots extend along the longitudinal axis of the tape, at the cross sectional mid point, and in a preferred embodiment are evenly spaced. With reference to FIG. 7, in a preferred embodiment, the slots 100 have a breadth “B” between 1.5 and 2.0 mm, a length “L1” of between 8 and 15 mm, and are spaced apart by a solid bridge 202 between the slots having a dimension “L2” of between 3 and 5 mm. Furthermore, the measuring index extending down the edge of the tape, shown by numeral 204 in FIG. 7, is replicated either by extension or duplication, and exemplified by numeral 206, to extend also down the center of the tape.

Thus, in use, the user may insert his pencil into a slot corresponding with the length that he wishes to inscribe on a work piece, as measured on the central measuring index 206, and makes a mark on the work piece through the slot. Where the mark that he wishes to inscribe falls under one of the bridges, he marks that point forward into the next slot by the amount L2 mm (which may be indicated on the tape), then removes the tape and places a second mark on the workpiece that is L2 mm shorter than the mark previously made. In this way, the user may accommodate the obstruction of the bridges with a slight adjustment to his initially inscribed length.

A further advantage of providing slots along the center line of a tape measure designed for large “standout” lengths is that the weight of the tape blade is significantly reduced by the removal of metal over a large length of the tape. This removed weight of metal has the effect of moving the point at which the tape would normally buckle under its own weight further away from the tip of the blade and thus has a second beneficial result because it gives the user a longer “standout” length than he would have had without the slots.

In a preferred aspect of the invention, the slots are interrupted for a distance of at least one foot on the blade where the maximum standout occurs. Thus, for example, if the tape is 25 feet long and has a maximum standout length of 10 feet, then the slots may be interrupted in the 9.5 feet to 10.5 feet distance from the tip of the blade (i.e. the tape has no slots in this length range). This has the effect of strengthening the tape in the region where it would tend to buckle under its own weight. Although this aspect may compel the user to use the edge measuring scale 204 (rather than the central measuring scale 206 via the aid of slots) for inscribing measurements in the range of 9.5 feet to 10.5 feet, this is a small price to pay for having the remaining 24 feet of the tape supplied with slots for easier inscription of measurement lengths.

Thus, the present invention also addresses with novel and useful features a need that is found in the art of tape measure blades having a large standout length, and are consequently highly curved. The present invention may, of course, be carried out in other specific ways than those herein set forth without departing from the essential characteristics of the invention. The present embodiments are, therefore, to be considered in all respects as illustrative and not restrictive.

We claim:

1. A tape measure comprising:
a housing;
an axle extending through the housing, the axle being rotationally fixed to the housing;
a spool having a tubular portion defining a bore shaped to receive the axle whereby the spool is configured to rotate about the axle, the spool further including at least one skirt rotationally fixed to the tubular portion;
a flat coiled tape lying in a first plane and having an inner terminal end and an outer terminal end, the inner terminal end being attached to the tubular portion so that the flat coiled tape rotates in unison with the spool, the outer terminal end extending from an opening in the housing and being configured to be withdrawn away from the housing to progressively unwind the coiled tape while rotating the tape and the spool in a first direction;
at least one flat coiled spring lying in a second plane adjacent to the first plane and having an inner terminal end and an outer terminal end, the inner terminal end being attached to the axle, the outer terminal end being attached to the skirt, whereby, when the spool rotates in the first direction the flat coiled spring is moved to a compressed condition, and when the spool rotates in a second direction opposite the first direction, the flat coiled spring moves to a decompressed condition;
whereby, when the external terminal end of the coiled tape is drawn away from the housing, the coiled tape and the spool are caused to rotate about the axle in the first direction, and the coiled spring is moved to a compressed condition; and
further whereby, when the external terminal end of the coiled tape is released, the coiled spring moves to the decompressed condition, thereby rotating the spool and the coiled tape in the second direction and withdrawing the tape into the housing.

2. The tape measure of claim 1, wherein the tubular portion defines a slot, and the inner terminal end of the flat coiled tape is attached to the tubular portion by being inserted in the slot in the tubular portion.

3. The tape measure of claim 1, wherein,
the at least one skirt is formed in the shape of a hollow cylinder that is open at a first end and closed at a second end opposite the first end, a slot is defined in an outer circumference of the hollow cylinder, the external end of the at least one flat coiled spring is attached to the skirt by being inserted into the slot in the outer circumference of the hollow cylinder; and
further wherein, the axle defines a slot, and the internal terminal end of the at least one flat coiled spring is attached to the axle by being inserted into the slot in the axle.

4. The tape measure of claim 3, wherein the at least one flat coiled spring is configured to fit within the circumference of the hollow cylinder.

5. The tape measure of claim 1, wherein the at least one skirt are two in number, and the at least one flat coiled spring are two in number, the two flat coiled springs being positioned about the axle to flank the flat coiled tape.

6. The tape measure of claim 1, wherein the housing has a spherical profile.

7. A tape measure comprising:
a housing;
a flat coiled tape blade positioned within the housing and configured to be withdrawn linearly from the housing, the tape blade having a curved cross sectional shape for maintaining a standout length under which the blade does not buckle under its own weight;
a flat coiled spring configured to retract the linearly withdrawn tape blade back into the housing;
wherein the tape blade is configured to include a series of slots extending down a center line of the tape blade and is further configured to include a measuring scale extending along an edge of the tape blade, and also to include a measuring scale extending along the center line of the tape blade adjacent the slots.

8. The tape measure of claim 7, wherein the slots have a length between 8 mm and 15 mm.

9. The tape measure of claim 8, wherein the slots have a width of between 1.5 mm and 2 mm.

10. The tape measure of claim 7, wherein the slots are evenly spaced.

11. The tape measure of claim 10, wherein the slots are separated from each other by a length of between 3 mm and 5 mm.

12. The tape measure of claim 7, wherein the slots are interrupted over a length of at least one foot at a location on the blade where the maximum blade standout occurs.
